(19) United States
(12) Patent Application Publication
(10) Pub. No.: US 2025/0053410 A1
(43) Pub. Date: Feb. 13, 2025

(54) FIRMWARE UPGRADE APPARATUS AND METHOD

(71) Applicant: ELECTRONICS AND TELECOMMUNICATIONS RESEARCH INSTITUTE, Daejeon (KR)

(72) Inventors: Seung Sik LEE, Daejeon (KR); Ho Yong KANG, Daejeon (KR); Ja Beom GU, Daejeon (KR); Dae Ho KIM, Daejeon (KR); Jung Sik SUNG, Daejeon (KR); Jun Hee LEE, Daejeon (KR)

(21) Appl. No.: 18/797,876

(22) Filed: Aug. 8, 2024

(30) Foreign Application Priority Data
Aug. 11, 2023 (KR) 10-2023-0105665

(51) Int. Cl. G06F 8/65

(52) U.S. Cl. CPC G06F 8/65

(57) ABSTRACT

A firmware upgrade apparatus and method are disclosed. A firmware upgrade apparatus according to some embodiments of the present invention includes access points, a relay configured to upload firmware data to the access point, a node configured to upload the firmware data to the relay, and an over-the-air (OTA) access point configured to upload the firmware data to the node.

### CROSS-REFERENCE TO RELATED APPLICATION

The present application claims priority to and the benefit of Korean Patent Application No. 10-2023-0105665, filed on Aug. 11, 2023, in the Korean Intellectual Property Office, the entire disclosure of which is incorporated herein by reference.

### BACKGROUND

### 1. Field of the Invention

The present invention relates to a firmware upgrade apparatus and method.

### 2. Description of Related Art

In a multi-hop environment, when over-the-air (OTA) is performed from an access point, firmware data is downloaded to a node from an access point through a relay.

For example, between an access point and a relay, OTA is initiated at the access point and the relay, and an OTA process is performed until the OTA is completed. Between relays, OTA is initiated at a relay at a subsequent stage, and an OTA process is performed until the OTA is completed. Between a relay and a node, OTA is initiated at the node, and an OTA process is initiated until the OTA is completed.

In other words, when OTA is performed in a multi-hop environment, firmware data is transmitted to an access point, relays at a plurality of stages, and nodes. However, in such a method, a considerable time delay occurs when firmware data is transmitted via a relay, and much time is taken to download a large amount of firmware data. In addition, when many nodes are connected to a relay, much time is taken to confirm success in transmitting the firmware data to the nodes.

### SUMMARY OF THE INVENTION

The present invention is directed to providing a firmware upgrade apparatus and method which reduce a time required for upgrading firmware with respect to relays and nodes in a multi-hop environment.

According to an aspect of the present invention, there is provided a firmware upgrade apparatus including access points, a relay configured to upload firmware data to the access point, a node configured to upload the firmware data to the relay, and an over-the-air (OTA) access point configured to upload the firmware data to the node.

The OTA access point may include a communication module, a database unit configured to store the firmware data, and an OTA processor configured to read the firmware data from the database unit and transmit the read firmware data to the node through the communication module.

The OTA access point may be at least one of the access points.

When entering an OTA mode, the node may be reset to be newly connected to the OTA access point and may communicate with the OTA access point at a preset communication speed.

When entering an OTA mode, the relay may be reset to be newly connected to at least one of the node, the access point, and another relay and may communicate with at least one of the node, the access point, and another relay at a preset communication speed.

After the firmware data is uploaded to all of the access point, the relay, and the node, each of the access point, the relay, and the node may update the firmware data.

The access point may transmit an update instruction to the relay, and the relay may transmit the update instruction to another relay or the node to update the firmware data.

The access point may update the firmware data when a preset waiting time has elapsed after the update instruction is transmitted to the relay, the relay may update the firmware data when a preset waiting time has elapsed after the update instruction is transmitted to another relay or the node, and the node may update the firmware data when a preset waiting time has elapsed after the update instruction is received.

According to another aspect of the present invention, there is provided a firmware upgrade apparatus including a communication module, a database unit configured to store firmware data, and an OTA processor configured to read the firmware data from the database unit and transmit the read firmware data to a node through the communication module.

The OTA processor may upload the firmware data at a preset communication speed through the communication module.

According to still another aspect of the present invention, there is provided a firmware upgrade method including uploading, by an OTA access point, firmware data to a node, uploading, by the node, the firmware data to a relay, and uploading, by the relay, the firmware data to another relay or access points.

The OTA access point may be at least one of the access points.

In the uploading, by the OTA access point, the firmware data to the node, when entering an OTA mode, the node may be reset to be newly connected to the OTA access point and may communicate with the OTA access point at a preset communication speed.

In the uploading, by the node, the firmware data to the relay, when entering an OTA mode, the relay may be reset to be newly connected to at least one of the node, the access point, and another relay and may communicate with at least one of the node, the access point, and another relay at a preset communication speed.

The firmware upgrade method may further including updating, by the access point, the relay, and the node, the firmware data.

In the updating, by the access point, the relay, and the node, the firmware data, after the firmware data is uploaded to all of the access point, the relay, and the node, each of the access point, the relay, and the node may update the firmware data.

In the updating, by the access point, the relay, and the node, the firmware data, the access point may update the firmware data when a preset waiting time has elapsed after an update instruction is transmitted to the relay, the relay may update the firmware data when a preset waiting time has elapsed after the update instruction is transmitted to another relay or the node, and the node may update the firmware data when a preset waiting time has elapsed after the update instruction is received.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram of a firmware upgrade apparatus according to one embodiment of the present invention;

FIG. 2 is a conceptual diagram illustrating a process of upgrading firmware according to one embodiment of the present invention;

FIG. 3 is a block diagram of an over-the-air (OTA) access point according to one embodiment of the present invention;

FIG. 4 is a block diagram of a node according to one embodiment of the present invention;

FIG. 5 is a block diagram of a relay according to one embodiment of the present invention;

FIG. 6 is a block diagram of an access point according to one embodiment of the present invention;

FIG. 7 is a flowchart illustrating a process of entering an OTA mode according to one embodiment of the present invention;

FIG. 8 is a flowchart illustrating a process of uploading firmware data to a node according to one embodiment of the present invention;

FIG. 9 is a flowchart illustrating a process of uploading firmware data to a relay according to one embodiment of the present invention;

FIG. 10 is a flowchart illustrating a process in which firmware data is uploaded between relays according to one embodiment of the present invention;

FIG. 11 is a flowchart illustrating a process of uploading data to an access point according to one embodiment of the present invention; and

FIG. 12 is a flowchart illustrating a process of updating firmware data of an access point, a relay, and a node according to one embodiment of the present invention.

### DETAILED DESCRIPTION OF EXEMPLARY EMBODIMENTS

Hereinafter, an example of a firmware upgrade apparatus and method according to one embodiment of the present invention will be described. The accompanying drawings are not necessarily to scale and in some instances, proportions may have been exaggerated in order to clearly illustrate features of the embodiments. Further, the terms to be described below are terms defined in consideration of functions in the present invention and thus may vary according to intentions or customs of users and operators. Accordingly, the definitions of such terms should be made based on the content throughout the specification.

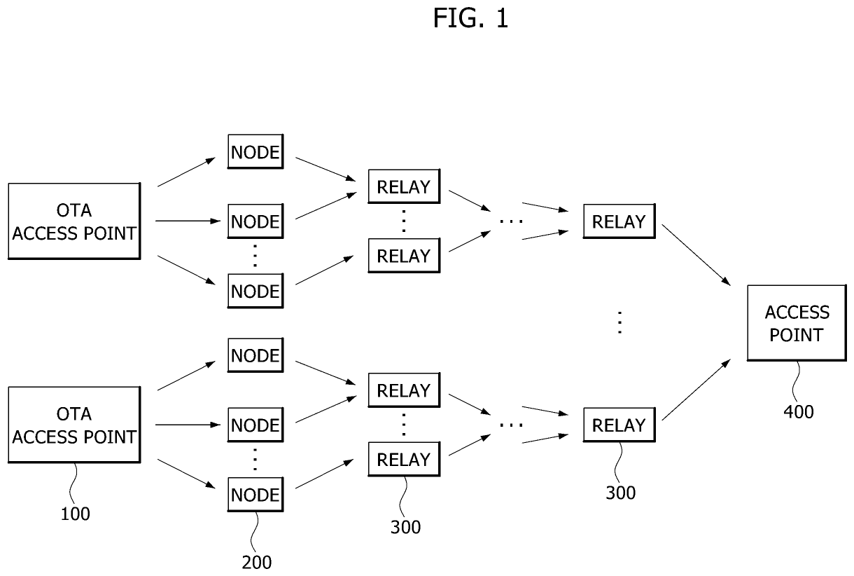

FIG. 1 is a block diagram of a firmware upgrade apparatus according to one embodiment of the present invention.

Referring to FIG. 1, a firmware upgrade apparatus according to one embodiment of the present invention includes over-the-air (OTA) access points (APs) 100, nodes 200, relays 300, and an AP 400.

The firmware upgrade apparatus according to one embodiment of the present invention updates firmware data in a multi-hop environment.

The firmware data is at least one of software, a program, a command, data, and the like for operations or functions such as booting, communicating, and interfacing of at least one of the node 200, the relay 300, and the AP 400 in the multi-hop environment. The type or function of the firmware data is not particularly limited.

In the firmware upgrade apparatus according to one embodiment of the present invention, the firmware data is transmitted from the OTA AP 100 to the plurality of nodes 200, the relays 300 at n higher stages, and the AP 400.

When the firmware data is completely uploaded, an update instruction is transmitted from the AP 400 to the relays 300 at n lower stages and the plurality of nodes 200. Afterwards, each of the plurality of nodes 200, the relays 300 at n stages, and the AP 400 update the firmware data.

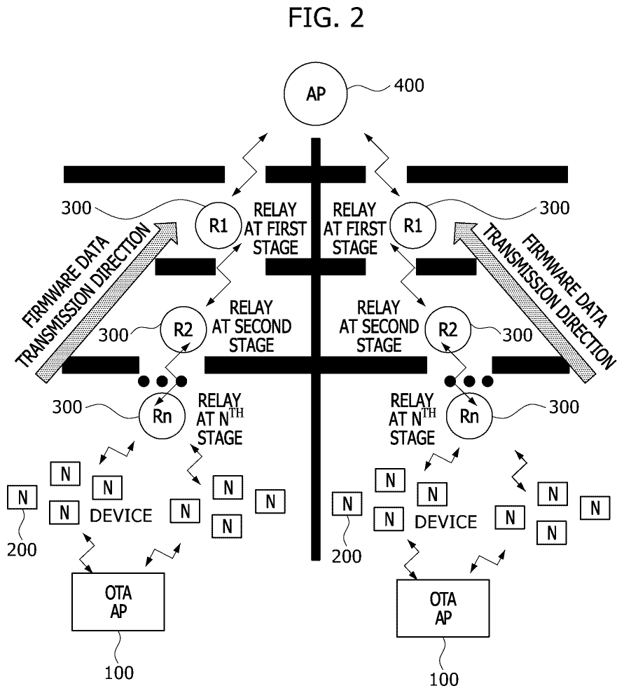

FIG. 2 is a conceptual diagram illustrating a process of upgrading firmware according to one embodiment of the present invention.

Referring to FIG. 2, the OTA AP 100 may upload firmware data to the plurality of nodes 200 through a multicasting method.

Generally, uploading through OTA of the node 200 takes relatively more time. Accordingly, the OTA AP 100 is directly connected to the plurality of nodes 200 and uploads the firmware data to each node 200, thereby reducing a time required for uploading the firmware data to the nodes 200.

The node 200 may upload the firmware data to the relay 300 at a higher stage.

The relay 300 may upload the firmware data to the relay 300 at a higher stage or the AP 400.

When the firmware data is uploaded to the AP 400, the AP 400 transmits an update instruction to the relay 300 at a lower stage. The update instruction may be a reset operation instruction for power restart, but is not particularly limited.

The AP 400 updates the firmware data when a preset waiting time has elapsed after the update instruction is transmitted. The waiting time will be described below.

The relay 300 may transmit the update instruction to the relay 300 at a lower stage or the node 200. The relay 300 or the relay 300 at a lower stage updates the firmware data when a preset waiting time has elapsed after the update instruction is transmitted.

The node 200 updates the firmware data after a preset waiting time has elapsed after the update instruction is received.

The waiting time is a time for which the AP 400, the relays 300 at n stages, and the nodes 200 wait after transmitting or receiving an update instruction.

The waiting time is set such that the AP 400, the relays 300 at n stages, and the nodes 200 simultaneously update the firmware.

When the AP 400, the relays 300 at n stages, and the nodes 200 upload the firmware data and then update is performed at different times, versions of firmware in the AP 400, the relays 300 at n stages, and the nodes 200 may be different. In this case, the AP 400, the relays 300 at n stages, and the nodes 200 may not communicate with each other or may operate abnormally.

For example, in a state in which the node 200 updates the firmware data and the relay 300 does not update the firmware data, the node 200 and the relay 300 may not communicate with each other. Alternatively, in a state in which the relay 300 updates the firmware data and the AP 400 does not update the firmware data, the relay 300 and the AP 400 may not communicated with each other.

That is, the waiting time may be set such that the AP 400, the relays 300 at n stages, and the nodes 200 simultaneously update the firmware data collectively in a state in which the firmware data is uploaded.

The waiting time may be set differently for the AP 400, the relays 300 at n stages, and the nodes 200.

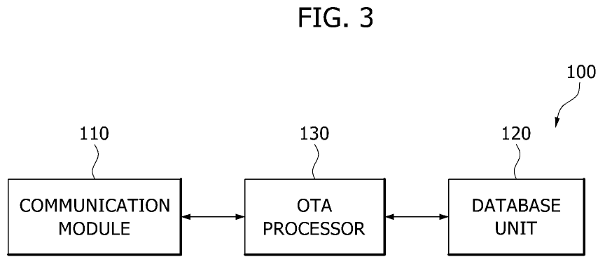

FIG. 3 is a block diagram of an OTA AP according to one embodiment of the present invention.

Referring to FIG. 3, the OTA AP 100 according to one embodiment of the present invention includes a communication module 110, a database unit 120, and an OTA processor 130.

The communication module 110 performs wireless communication with the node 200.

The communication module 110 may transmit firmware data to the node 200.

The database unit 120 may store the firmware data.

The OTA processor 130 may transmit the firmware data to the node 200 when connected to the node 200 through the communication module 110 in an OTA mode.

The OTA processor 130 may transmit the firmware data through the communication module 110 at a preset communication speed, for example, the highest communication speed.

The OTA AP 100 may be provided separately from the existing AP 400. The OTA AP 100 may be manufactured separately to upload the firmware data. Alternatively, the OTA AP 100 may be at least one selected from the APs 400 provided in a multi-hop environment.

The OTA AP 100 may be installed as a fixed type, but may be installed as a mobile type.

When the OTA AP 100 is installed as the mobile type, the OTA AP 100 may be disposed at any one of various locations in consideration of the number or arrangement locations of the nodes 200.

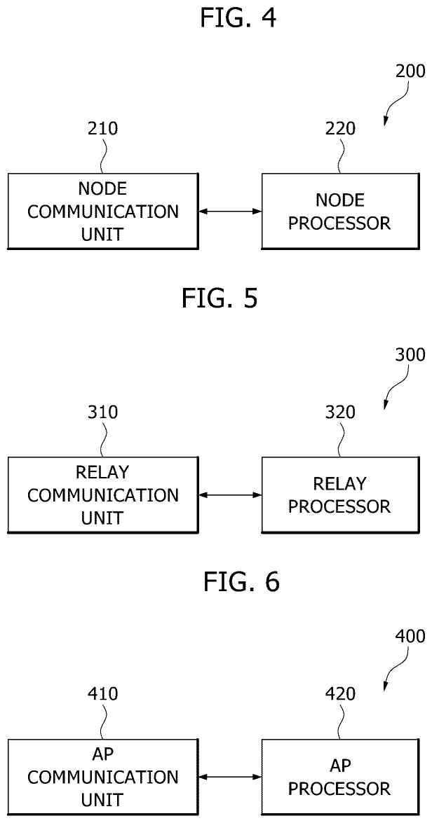

FIG. 4 is a block diagram of a node according to one embodiment of the present invention.

Referring to FIG. 4, the node 200 includes a node communication unit 210 and a node processor 220.

The node communication unit 210 communicates with the relay 300 and the OTA AP 100.

The node communication unit 210 may receive an OTA mode entry instruction from the relay 300.

The node communication unit 210 may receive an update instruction from the relay 300.

The node communication unit 210 may receive firmware data from the OTA AP 100 at a preset speed.

The node processor 220 may communicate with the relay 300 and the OTA AP 100 through the node communication unit 210.

The node processor 220 resets the node 200 according to the OTA mode entry instruction received from the upper relay 300. According to the reset, the node processor 220 is connected to the surrounding OTA AP 100 and the node communication unit 210.

The node processor 220 may store the firmware data after receiving the firmware data from the OTA AP 100 through the node communication unit 210 at a set speed, for example, the highest communication speed.

The node processor 220 may transmit the firmware data received from the OTA AP 100 to the relay 300 through the node communication unit 210 and may wait after reset.

The node processor 220 may receive the update instruction from the relay 300 through the node communication unit 210.

The node processor 220 may update the firmware data when a preset waiting time has elapsed after the update instruction is received.

FIG. 5 is a block diagram of a relay according to one embodiment of the present invention.

Referring to FIG. 5, the relay 300 includes a relay communication unit 310 and a relay processor 320.

The relay communication unit 310 may communicate with the node 200, another relay 300, or the AP 400.

Another relay 300 may be the relay 300 at a higher stage or the relay 300 at a lower stage.

The relay communication unit 310 may receive an OTA mode entry instruction from the AP 400 or the relay 300 at a higher stage.

The relay communication unit 310 may transmit the OTA entry command to the node 200 or the relay 300 at a lower stage.

The relay communication unit 310 may receive an update instruction from the AP 400 or the relay 300 at a higher stage.

The relay communication unit 310 may transmit the update instruction to the node 200 or the relay 300 at a lower stage.

The relay processor 320 may communicate with the node 200, another relay 300, and the AP 400 through the relay communication unit 310.

The relay processor 320 resets the relay 300 according to the OTA mode entry instruction received from the relay 300 at a higher stage or the AP 400. According to the reset, the relay processor 320 is connected to the surrounding node 200, another relay 300, or the AP 400 through the relay communication unit 310.

The relay processor 320 may store the firmware data after receiving the firmware data from the node 200 through the relay communication unit 310 at a set speed, for example, the highest communication speed.

The relay processor 320 compares a version of the firmware data received from the node 200 or another relay 300 with a version of currently stored firmware data to check whether the version of the received firmware data matches the version of the currently stored firmware data. When the version of the firmware data received from the node 200 or another relay 300 is different from the version of the currently stored firmware data, the relay processor 320 requests firmware data from the node 200 or another relay 300 through the relay communication unit 310. In this case, the node 200 or another relay 300 may upload the firmware data to the corresponding relay 300.

Meanwhile, the relay processor 320 transmits the firmware data to the relay 300 at a higher stage or the AP 400 through the relay communication unit 310 and waits after reset.

The relay processor 320 may receive an update instruction from the upper relay 300 or the AP 400 through the relay communication unit 310.

The relay processor 320 may update the firmware data when a preset waiting time has elapsed after the update instruction is received.

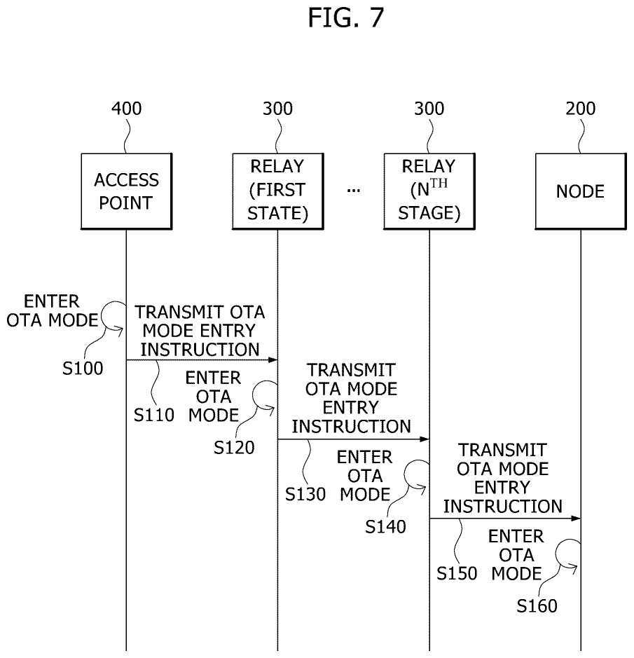

FIG. 6 is a block diagram of an AP according to one embodiment of the present invention.

Referring to FIG. 6, the AP 400 includes an AP communication unit 410 and an AP processor 420.

The AP communication unit 410 may communicate with the relay 300.

The AP communication unit 410 may transmit an OTA mode entry instruction to the relay 300.

The AP communication unit 410 may receive firmware data from the relay 300.

The AP communication unit 410 may transmit an update instruction to the relay 300.

The AP processor 420 may communicate with the relay 300 through the AP communication unit 410.

The AP processor 420 resets the AP 400 in an OTA mode.

According to the reset, the AP processor 420 is connected to the surrounding relay 300 through the AP communication unit 410.

The AP processor 420 may store the firmware data after receiving the firmware data from the relay 300 through the AP communication unit 410 at a set speed, for example, the highest communication speed.

The AP processor 420 compares a version of the firmware data received from the relay 300 with a version of currently stored firmware data to check whether the version of the received firmware data matches the version of the currently stored firmware data. When the version of the firmware data received from the relay 300 is different from the version of the currently stored firmware data, the AP processor 420 may request firmware data from the relay 300. In this case, the relay 300 may upload the firmware data.

When the firmware data is uploaded, the AP processor 420 may transmit an update instruction to the relay 300 through the AP communication unit 410.

The AP processor 420 may update the firmware data when a preset waiting time has elapsed after the update instruction is transmitted to the relay 300 through the AP communication unit 410.

The processor may be implemented as various types, such as an application processor (AP), a central processing unit (CPU), a graphics processing unit (GPU), and the like, and may be a semiconductor device which executes commands stored in the memory or the storage device. The processor may execute program commands stored in at least one of the memory and the storage device. The processor may be configured to implement the foregoing functions and methods to be described below.

The memory and the storage device may include various forms of volatile or non-volatile storage media. For example, the memory may include a read-only memory (ROM) and a random access memory (RAM). In an exemplary embodiment of the present disclosure, the memory may be present in or outside the processor, and the memory may be connected to the processor using various known methods.

The communication unit such as network interface device may transmit or receive signals to or from another device through a wired network or a wireless network.

Hereinafter, a firmware upgrade method according to one embodiment of the present invention will be described with reference to FIGS. 7 to 12.

FIG. 7 is a flowchart illustrating a process of entering an OTA mode according to one embodiment of the present invention.

Referring to FIG. 7, first, the AP 400 enters the OTA mode (S100).

The AP 400 transmits an OTA mode entry instruction to the relay 300 at the lowest stage (first stage) (S110).

The relay 300 at the lowest stage (first stage) enters the OTA mode (S120) and transmits the OTA mode entry instruction to the relay 300 at a higher stage (second stage). In this way, a process in which the relay 300 at a lower stage enters the OTA mode and transmits the OTA mode entry instruction to the relay 300 at a higher stage is repeated up to the relay 300 at the highest stage (nth stage) (S130 and S140).

The relay 300 at the highest stage (nth stage) enters the OTA mode and transmits the OTA mode entry instruction to the node 200 (S150).

The node 200 enters the OTA mode according to the OTA mode entry instruction (S160).

As described above, in a state in which the OTA AP 100, the relay 300, the AP 400, and the node 200 enter the OTA mode, the OTA AP 100 uploads firmware data to the node 200.

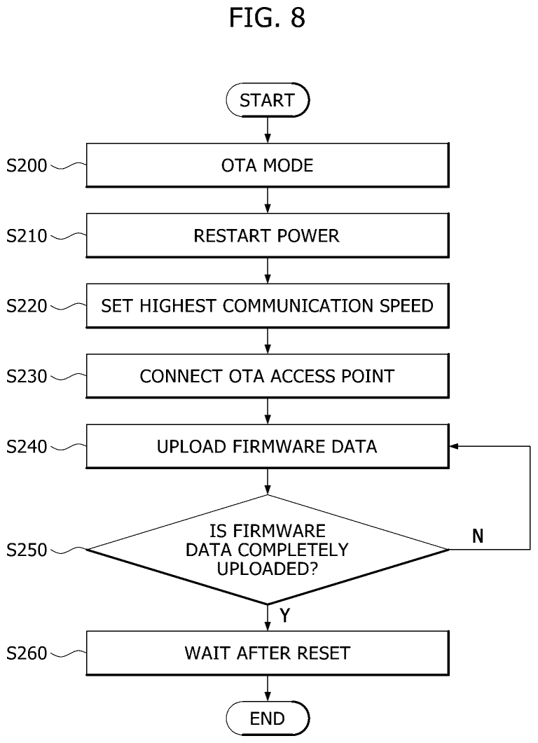

FIG. 8 is a flowchart illustrating a process of uploading firmware data to a node according to one embodiment of the present invention.

Referring to FIG. 8, in a state in which the node 200 enters the OTA mode (S200), the node 200 restarts power (S210).

The node 200 resets the power (S210) and sets a speed for communicating with the OTA AP 100 to the highest communication speed (S220).

As the power is restarted, the node 200 is connected to the OTA AP 100 (S230).

As the node 200 and the OTA AP 100 are connected, the OTA AP 100 uploads the firmware data to the node 200 at the highest communication speed (S240).

The node 200 checks whether the firmware data is completely uploaded (S250).

When the upload is not completed, the firmware data is continuously uploaded to the node 200, and when the upload is completed, the node 200 waits after reset (S260).

As described above, as the firmware data is uploaded to the node 200, the node 200 uploads the firmware data to the relay 300 at the lowest stage.

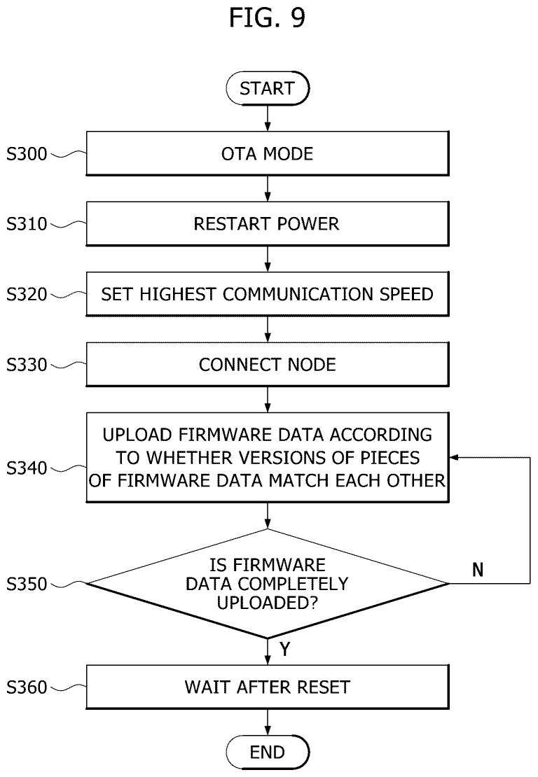

FIG. 9 is a flowchart illustrating a process of uploading firmware data to a relay according to one embodiment of the present invention.

Referring to FIG. 9, the relay 300 at the lowest stage enters an OTA mode (S300), restarts power (S310), and sets a speed for communicating with the node 200 to the highest communication speed (S320).

As the power is restarted, the relay 300 at the lowest stage is connected to the node 200 (S330).

As the relay 300 at the lowest stage is connected to the node 200, the relay 300 at the lowest stage compares a version of the firmware data uploaded to the node 200 with a version of currently stored firmware data to check whether the version of the uploaded firmware data matches the version of the currently stored firmware data. In this case, the node 200 uploads the firmware data to the relay 300 at the lowest stage according to whether the versions match each other (S340).

That is, the relay 300 at the lowest stage may receive the version of the firmware data uploaded to the node 200. The relay 300 at the lowest stage checks whether the version of the firmware data uploaded to the node 200 matches the version of the currently stored firmware data and transmits a check result to the node 200. In this case, when the version of the firmware data uploaded to the node 200 does not match the version of the firmware data stored in the relay 300 at the lowest stage, the node 200 uploads the firmware data to the relay 300 at the lowest stage according to a request of the relay 300 at the lowest stage (S340).

The relay 300 at the lowest stage checks whether the firmware data is completely uploaded (S350).

When the upload is not completed, the firmware data is continuously uploaded to the relay 300 at the lowest stage, and when the upload is completed, the relay 300 at the lowest stage waits after reset (S360).

As the firmware data is uploaded to the relay 300 at the lowest stage, the firmware data is uploaded step by step from the relay 300 at the lowest stage to the relay 300 at the highest stage.

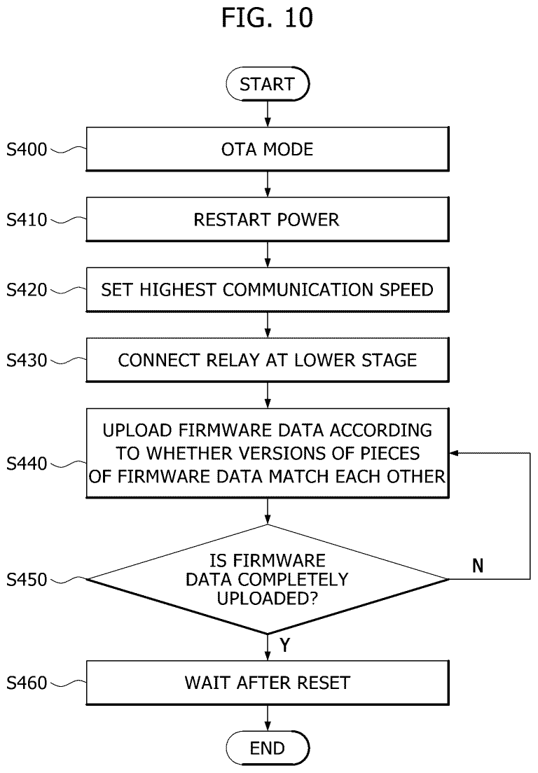

FIG. 10 is a flowchart illustrating a process in which firmware data is uploaded between relays according to one embodiment of the present invention.

Referring to FIG. 10, the relay 300 at the higher stage enters an OTA mode (S400), restarts power (S410), and sets a speed for communicating with the relay 300 at a lower stage to the highest communication speed. (S420).

As the power is restarted, the relay 300 at a higher stage is connected to the relay 300 at a lower stage (S430).

As the relay 300 at a higher stage is connected to the relay 300 at a lower stage, the relay 300 at a higher stage compares a version of firmware data uploaded to the relay 300 at a lower stage with a version of currently stored firmware data to check whether the version of the uploaded firmware data matches the version of the currently stored firmware data. In this case, the relay 300 at a lower stage uploads the firmware data to the relay 300 at a higher stage according to whether the versions match each other (S440).

That is, the relay 300 at a higher stage may receive the version of the firmware data uploaded to the relay 300 at a lower stage. The relay 300 at a higher stage checks whether the version of the firmware data uploaded to the relay 300 at a lower stage matches the version of the currently stored firmware data and transmits a check result to the relay 300 at a lower stage. In this case, when the version of the firmware data uploaded to the relay 300 at a higher stage does not match the version of the firmware data stored in the relay 300 at a lower stage, the relay 300 at a lower stage uploads the firmware data to the relay 300 at a higher stage according to a request of the relay 300 at a higher stage.

The relay 300 at a higher stage checks whether the firmware data is completely uploaded (S450).

When the upload is not completed, the firmware data is continuously uploaded to the relay 300 at a higher stage, and when the upload is completed, the relay 300 at a higher stage waits after reset (S460).

When the firmware data is uploaded to the relay 300 at the highest stage through the above process, the relay 300 at the highest stage uploads the firmware data to the AP 400.

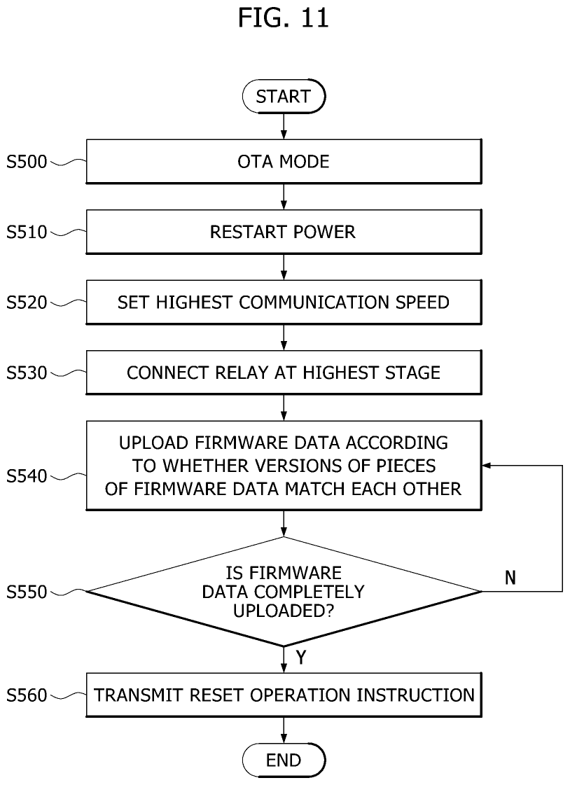

FIG. 11 is a flowchart illustrating a process of uploading data to an AP according to one embodiment of the present invention.

Referring to FIG. 11, the AP 400 enters an OTA mode (S500), restarts power (S410), and sets a speed for communicating with the relay 300 at the highest stage to the highest communication speed (S520).

As the power is restarted, the AP 400 is connected to the relay 300 at the highest stage (S530).

As the AP 400 is connected to the relay 300 at the highest stage, the AP 400 compares a version of firmware data uploaded to the relay 300 at the highest stage with a version of currently stored firmware data to check whether the version of the uploaded firmware data matches the version of the currently stored firmware data. In this case, the relay 300 at the highest stage uploads the firmware data to the AP 400 according to whether the versions match each other (S540).

That is, the AP 400 may receive the version of the firmware data uploaded to the relay 300 at the highest stage. The AP 400 checks whether the version of the firmware data uploaded to the relay 300 at the highest stage matches the version of the currently stored firmware data and transmits a check result to the relay 300 at the highest stage. In this case, when the version of the firmware data uploaded to the AP 400 does not match the version of the firmware data stored in the relay 300 at the highest stage, the relay 300 at the highest stage uploads the firmware data to the AP 400 according to a request of the AP 400.

The AP 400 checks whether the firmware data is completely uploaded (S550).

When the upload is not completed, the firmware data is continuously uploaded to the AP 400, and when the upload is completed, the AP 400 transmits a reset operation instruction to the relay 300 at the highest stage (S560).

As described above, when the firmware data is uploaded to the AP 400, the AP 400 transmits an update instruction, that is, a reset operation instruction, to the relay 300 at the highest stage. The reset operation instruction is transmitted to the node 200 through the relays 300 at a plurality of stages.

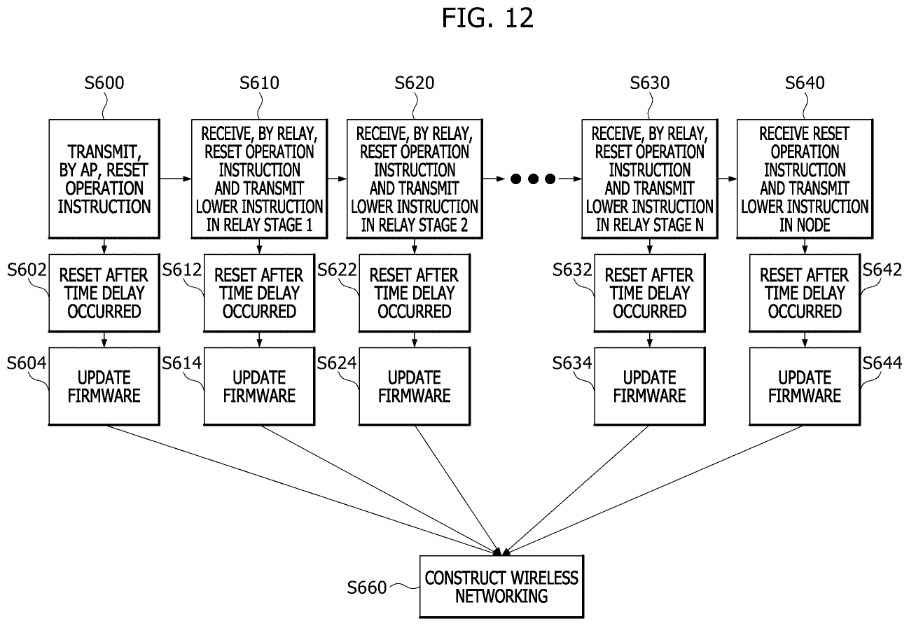

FIG. 12 is a flowchart illustrating a process of updating firmware data of an AP, a relay, and a node according to one embodiment of the present invention.

Referring to FIG. 12, the AP 400 transmits a reset operation instruction to the relay 300 at the highest stage (stage 1) (S600). The AP 400 is reset to update firmware data when a preset waiting time has elapsed after the reset operation instruction is transmitted (S602 and S604).

The relay 300 at the highest stage (stage 1) transmits the reset operation instruction to the relay 300 at a subsequent stage (stage 2) (S610). The relay 300 at a subsequent stage (stage 2) is reset to update the firmware data when a preset waiting time has elapsed after the reset operation instruction is transmitted (S612 and S614).

The relay 300 at each stage is reset to update the firmware data when a preset waiting time has elapsed after the reset operation instruction is transmitted or received to or from the relay 300 at lower stages (S600, S612, and S614).

The relay 300 at the lowest stage (stage n) transmits the reset operation instruction to the node 200 (S600). The node 200 is reset to update the firmware data when a preset waiting time has elapsed after the reset operation instruction is transmitted (S602 and S604).

In this way, the AP 400, the relay 300 at each stage, and the node 200 are collectively reset according to the reset operation instruction to update the firmware data, thereby constructing wireless networking.

In a firmware upgrade apparatus and method according to one aspect of the present invention, when a wireless link is constructed through multi-hop in a wireless communication environment, a time required for upgrading firmware with respect to relays and nodes is reduced.

The present invention has been described with reference to embodiments shown in the drawings, but this is merely illustrative, and those skilled in the art will understand that various modifications and other equivalent embodiments are possible therefrom. Therefore, the technical protection scope of the present invention should be defined by the appended claims.

What is claimed is:

1. A firmware upgrade apparatus comprising:
access points;
a relay configured to upload firmware data to the access point;
a node configured to upload the firmware data to the relay; and
an over-the-air (OTA) access point configured to upload the firmware data to the node.

2. The firmware upgrade apparatus of claim 1, wherein the OTA access point includes:
a communication module;
a database unit configured to store the firmware data; and
an OTA processor configured to read the firmware data from the database unit and transmit the read firmware data to the node through the communication module.

3. The firmware upgrade apparatus of claim 1, wherein the OTA access point is at least one of the access points.

4. The firmware upgrade apparatus of claim 1, wherein, when entering an OTA mode, the node is reset to be newly connected to the OTA access point and communicates with the OTA access point at a preset communication speed.

5. The firmware upgrade apparatus of claim 1, wherein, when entering an OTA mode, the relay is reset to be newly connected to at least one of the node, the access point, and another relay and communicates with at least one of the node, the access point, and another relay at a preset communication speed.

6. The firmware upgrade apparatus of claim 1, wherein, after the firmware data is uploaded to all of the access point, the relay, and the node, each of the access point, the relay, and the node updates the firmware data.

7. The firmware upgrade apparatus of claim 6, wherein the access point transmits an update instruction to the relay, and
the relay transmits the update instruction to another relay or the node to update the firmware data.

8. The firmware upgrade apparatus of claim 7, wherein the access point updates the firmware data when a preset waiting time has elapsed after the update instruction is transmitted to the relay,
the relay updates the firmware data when a preset waiting time has elapsed after the update instruction is transmitted to another relay or the node, and
the node updates the firmware data when a preset waiting time has elapsed after the update instruction is received.

9. A firmware upgrade apparatus comprising:
a communication module;
a database unit configured to store firmware data; and
an over-the-air (OTA) processor configured to read the firmware data from the database unit and transmit the read firmware data to a node through the communication module.

10. The firmware upgrade apparatus of claim 9, wherein the OTA processor uploads the firmware data at a preset communication speed through the communication module.

11. A firmware upgrade method comprising:
uploading, by an over-the-air (OTA) access point, firmware data to a node;
uploading, by the node, the firmware data to a relay; and
uploading, by the relay, the firmware data to another relay or access points.

12. The firmware upgrade method of claim 11, wherein the OTA access point is at least one of the access points.

13. The firmware upgrade method of claim 11, wherein, in the uploading, by the OTA access point, the firmware data to the node, when entering an OTA mode, the node is reset to be newly connected to the OTA access point and communicates with the OTA access point at a preset communication speed.

14. The firmware upgrade method of claim 11, wherein, in the uploading, by the node, the firmware data to the relay, when entering an OTA mode, the relay is reset to be newly connected to at least one of the node, the access point, and another relay and communicates with at least one of the node, the access point, and another relay at a preset communication speed.

15. The firmware upgrade method of claim 11, further comprising updating, by the access point, the relay, and the node, the firmware data.

16. The firmware upgrade method of claim 15, wherein, in the updating, by the access point, the relay, and the node, the firmware data, after the firmware data is uploaded to all of the access point, the relay, and the node, each of the access point, the relay, and the node updates the firmware data.

17. The firmware upgrade method of claim 16, wherein, in the updating, by the access point, the relay, and the node, the firmware data, the access point updates the firmware data when a preset waiting time has elapsed after an update instruction is transmitted to the relay, the relay updates the firmware data when a preset waiting time has elapsed after the update instruction is transmitted to another relay or the node, and the node updates the firmware data when a preset waiting time has elapsed after the update instruction is received.
